(19) United States
(12) Patent Application Publication
(10) Pub. No.: US 2017/0015852 A1
(43) Pub. Date: Jan. 19, 2017

(54) INK COMPOSITION

(71) Applicant: KERACOL LIMITED, Leeds (GB)

(72) Inventors: Meryem BENOHOUD, Leeds, Yorkshire (GB); Alenka TIDDER, Leeds, Yorkshire (GB); Richard Simon BLACKBURN, Leeds, Yorkshire (GB); Christopher Mark RAYNER, Leeds, Yorkshire (GB)

(73) Assignee: KERACOL LIMITED, LEEDS (UK)

(21) Appl. No.: 15/121,793

(22) PCT Filed: Feb. 26, 2015
(86) PCT No.: PCT/GB2015/050547

§ 371 Date: Aug. 26, 2016

(30) Foreign Application Priority Data
Feb. 28, 2014 (GB) 1403570.3

(51) Int. Cl. C09D 11/17; A23P 20/10; A23L 15/00

(52) U.S. Cl. CPC C09D 11/17; A23L 15/00; A23P 20/10; A23V 2002/00

(57) ABSTRACT

The invention describes an ink composition for marking a substrate, said ink composition comprising at least one water miscible C₁ to C₄ aliphatic alcohol,water and a colorant. The colorant can be obtained from a natural source and can comprise one or more compounds selected from the group consisting of: anthocyanins, curcumin and carminic acid. The invention also concerns the use of the ink composition in the marking of food products and particularly in the marking of eggshells. Methods of applying the ink composition are also disclosed.

This invention relates to an ink composition having a naturally derived colorant. In certain embodiments, the invention concerns the use of the ink composition in the marking of food products and particularly in the marking of eggshells. Methods of applying the ink composition are also disclosed.

### BACKGROUND

Since 2004 regulations in the European Union (EU) require all Class A eggs to be marked with a code identifying the method of production, country of origin and the production establishment. Consumers have become more discerning about where their eggs come from and therefore traceability is now very important. An increase in welfare conscious consumers has resulted in “free range” eggs achieving the major market share.

Typically, the coding ink used for egg labelling should be composed of food grade materials and must not be applied in excess to prevent penetration through the shell. Furthermore, it is stipulated in EU legislation (Reg 1274/91) that the eggshell be marked in an indelible colour resistant to boiling.

At present, the only approved synthetic colorant in the EU that binds to eggs and provides water-fast codes with acceptable performance is erythrosine, a red colorant. However, erythrosine has numerous associated health and safety concerns and restriction of its use in the near future is becoming increasingly likely. Erythrosine has already been banned for use in externally applied cosmetics and, although erythrosine is still used in the EU, the United States Food and Drug Administration (USFDA) instituted a partial ban in 1990 citing research that indicated high doses were found to cause cancer in rats. Pressure from public interest groups has since been mounting for the complete removal of erythrosine from USFDA and EU lists. If erythrosine use in food is prohibited globally, there would be serious security and safety implications for the egg industry due to the lack of suitable alternatives.

Further disadvantages associated with erythrosine include its poor ethanol solubility. In order to achieve high print definition to enable barcodes and QR codes to be directly printed onto substrates such as eggs, inks should most preferably be capable of being formulated using a high ethanol content. As erythrosine is used at a concentration of 1.5% w/v but only has a solubility of 0.79% w/v in ethanol, its useful application is limited.

Alternative ink compositions based on existing natural food colorants have often proved to be unsuccessful when applied to eggshells due to issues relating to low adhesion, poor colour fastness, incompatibility in delivery solvent and high sodium sulphate content (<0.05% required). A major problem associated with existing food grade dyes is their lack of solubility in ethanol meaning that they frequently cannot be used as a stable inkjet ink. For this reason, there are only a limited number of food grade formulations that are suitable for application to substrates such as eggshells.

JP11172167 discloses an aqueous formulation comprising cochineal lac, jasmine, turmeric, kaoliang-, red sandal-, madder-, and lithospermum-based colorants. In addition, the formulation also contains alkali metal alginates, metal chelates, propylene glycol alginate ester, calcium carboxymethylcellulose, sodium carboxymethylcellulose, glycerol fatty acid esters, sucrose fatty acid esters, sorbitan fatty acid esters, sodium starch glycolate, sodium starch phosphate, sodium polyacrylate, propylene glycol fatty acid esters and methylcellulose.

JP2007106915 describes edible inks containing bamboo charcoal, octane, Moresco-White P-40 (liquid paraffin), DK Ester O-10 (sucrose stearate surfactant), and lecithin.

JP2007106912 describes the use of edible ink-jet inks containing oil-soluble food dyes, water and/or water-soluble solvents as food additives and food emulsifiers. The formulation specifically contains the food dyes Chloron GA (Cu chlorophyll), Rikecolor Paprika 240R(G) (paprika pigment) along with the surfactants Sorgen 30V, DK Ester F-160, and K tripolyphosphate.

EP911372 describes a water-fast ink for marking an eggshell surface. One disclosed example provides a composition comprising sodium iron chlorophyllin (1.50%), sodium alginate (0.14%), sodium lactate (3.00%), propylene glycol (14.00%) and water (81.36%).

Chlorophyll as a colouring matter is also described in JP2010037527 which discloses inks comprising iron chlorophyllin sodium and/or sodium copper chlorophyllin, alginic acid alkali metal salts, propylene glycol, silicon compounds and water.

JP2007056190 describes inks suitable for marking eggshells comprising a 90% aqueous ethanol based ink containing Monascus koji dye, shellac solution, propylene glycol, a 1:1:1 sodium lactate-lactic acid-water mixture and water.

JP4696653 describes inkjet inks comprising 70-90% ethanol containing colorants of ethanol-soluble kaoliang dyes or rosewood dyes, shellac, sodium lactate, acetic acid, propionic acid, lactic acid, or propylene glycol.

GB2277094 describes an ink-jet ink comprising colourant, binder and solvent and is characterised in that the solvent is a mixture of 60-76% by volume ethanol and 40-14% by volume water. Although other food grade colourants are mentioned, only erythrosine is exemplified within an ink to form boil resistant deposits on eggshells.

Embodiments of the present disclosure seek to overcome or ameliorate one or more of the above-noted problems of the prior art. Specifically, there are needed alternative ink compositions that can be applied to substrates which have reduced environmental and toxicological impact without compromising product performance. Furthermore, there is a particular need for improved, environmentally sound ink compositions that can be effectively applied to the surface of eggshells and provide a high print quality.

### BRIEF SUMMARY OF THE DISCLOSURE

In a first aspect of the invention there is provided an ink composition for marking a substrate, said ink composition comprising at least one water miscible C₁ to C₄ aliphatic alcohol, water and a colorant. The colorant can be obtained from a natural source and can comprise one or more compounds selected from the group consisting of: anthocyanins, curcumin and carminic acid.

In some advantageous embodiments said ink composition has a low environmental and toxicological impact whilst still exhibiting high solubility and high affinity for the surface of the substrate.

In some embodiments said colorant can consist of one or more compounds selected from the group consisting of: anthocyanins, curcumin and carminic acid.

In some embodiments said colorant can comprise at least one compound selected from anthocyanins or at least one compound selected from curcumin.

In some embodiments said colorant can consist of at least one compound selected from anthocyanins or at least one compound selected from curcumin.

In particularly preferred embodiments said substrate can be an eggshell. In some advantageous embodiments said ink composition can demonstrate high affinity for eggshells and enable the application of a durable, water-fast mark on the shell surface with no penetration through the shell and into the egg white and yolk. Furthermore, said ink composition can provide a means of marking eggshells with an alternative colorant to erythrosine. Thus in some embodiments, said ink composition can be free or substantially free from erythrosine. In this context “substantially free from erythrosine” refers to ink compositions that comprise less than 10%, preferably less than 5%, more preferably less than 1%, more preferably less than 0.1% and most preferably less than 0.01% erythrosine by weight of the total composition.

In some embodiments said ink composition can consist of food grade materials. Thus in some advantageous embodiments said substrate can be the surface of a foodstuff.

In some embodiments said colorant can comprise at least one compound selected from anthocyanins. In some embodiments said colorant can consist of one or more anthocyanin compounds. Thus in some advantageous embodiments the presence of at least one anthocyanin compound facilitates the ease of colour control of the ink compositions as the observed colour arising from such compounds can be adjusted by varying their chemical environment. Furthermore, the inclusion of at least one anthocyanin compound can introduce blue to the colour palette provided by the ink composition of the invention.

In some embodiments said anthocyanins can be obtained from a botanical source. In some embodiments said botanical source can be selected from blackcurrants (Ribes nigrum), blackberries (Rubus spp.), blueberries, cranberries (Vaccinium spp.), bilberries (especially Vaccinium myrtillus), strawberries (Fragaria spp.), grapes (Vitis spp.), chokeberries (Aronia spp.), Saskatoon berries (Amelanchier anifolia), sea-buckthorn (Hippophae spp.), mulberries (Morus spp.), acai (Euterpe spp.), cherries (Prunus spp.), red cabbage (Brassica spp.), black carrots (Daucus carota), and/or figs (Ficus spp.). In some embodiments said botanical source can be fruit.

In some embodiments said anthocyanin compounds are aglycone anthocyanidins or glycosylated anthocyanins of the formula (I):

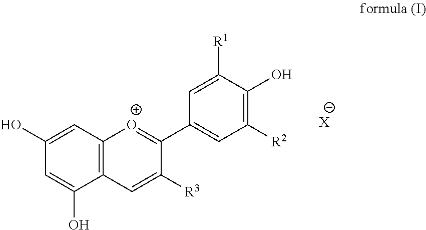

wherein R¹ and R² are, independently, H, OH or OCH₃, R³ is OH (aglycone anthocyanidin) or an O-glycosyl group (glycosylated anthocyanins), and X is a counter ion.

In some embodiments X can be selected from the group of anions whose conjugate acids have a pKₐ of less than 10. In some embodiments X can be selected from the group of anions whose conjugate acids have a pKₐ of less than 6. Optionally X can be selected from the group consisting of: chloride, bromide, iodide, sulphate, bisulphate, carbonate, bicarbonate, citrate, succinate, oxalate, ascorbate, lactate, formate, acetate and tartrate.

In some embodiments said O-glycosyl group can comprise a monosaccharide or polysaccharide.

In some embodiments said polysaccharide can comprise a disaccharide or trisaccharide.

In some embodiments said monosaccharide can be selected from O-glucoside, O-rhamnoside, O-arabinoside, O-xyloside and O-galactoside.

In some embodiments said disaccharide can be selected from O-rutinoside, Osophoroside and O-primeveroside.

In some embodiments said ink composition can comprise said anthocyanin compounds in an amount of about 0.01% to about 10% by weight of the total composition.

In some embodiments said ink composition can further comprise at least one organic acid. In some embodiments said at least one organic acid can have 1 to 6 carbon atoms. In some embodiments said at least one organic acid can have pKₐ values of less than 10. In some embodiments said at least one organic acid can have pKₐ values between 1 and 5.

In some embodiments said at least one organic acid can comprise one or more carboxylic acid moieties.

In some embodiments said at least one organic acid can be selected from the group consisting of: acetic acid, gluconic acid, lactic acid, formic acid, citric acid, malic acid, succinic acid, glutaric acid, oxalic acid, adipic acid, fumaric acid, tartaric acid and ascorbic acid.

The inclusion of said at least one organic acid can enhance the binding of the colorant to the substrate.

In some embodiments said at least one organic acid can be acetic acid. In some advantageous embodiments the presence of acetic acid can substantially enhance the binding of the colorant to the substrate and particularly wherein the colorant comprises at least one compound selected from anthocyanins and the substrate is an eggshell.

In some embodiments said ink composition can comprise said at least one organic acid in an amount of about 0.1% to about 30% by weight of the total composition.

In some embodiments said ink composition can comprise said at least one organic acid in an amount of about 0.1% to about 25% by weight of the total composition. In some embodiments said ink composition can comprise said at least one organic acid in an amount of about 0.1% to about 20% by weight of the total composition. In some embodiments said ink composition can comprise said at least one organic acid in an amount of about 0.1% to about 15% by weight of the total composition. In some embodiments said ink composition can comprise said at least one organic acid in an amount of about 0.1% to about 10% by weight of the total composition.

In some embodiments said ink composition can comprise at least 10% of said at least one water miscible C₁ to C₄ aliphatic alcohol by weight of the total composition. In some embodiments said ink composition can comprise at least 20% of said at least one water miscible C₁ to C₄ aliphatic alcohol by weight of the total composition. In some embodiments said ink composition can comprise at least 30% of said at least one water miscible C₁ to C₄ aliphatic alcohol by weight of the total composition. In some embodiments said ink composition can comprise at least 40% of said at least one water miscible C₁ to C₄ aliphatic alcohol by weight of the total composition. In some embodiments said ink composition can comprise at least 60% of said at least one water miscible C₁ to C₄ aliphatic alcohol by weight of the total composition. In some embodiments said ink composition can comprise at least 75% of said at least one water miscible C₁ to C₄ aliphatic alcohol by weight of the total composition. In some embodiments said ink composition can comprise at least 80% of said at least one water miscible C₁ to C₄ aliphatic alcohol by weight of the total composition. In some embodiments said ink composition can comprise at least 95% of said at least one water miscible C₁ to C₄ aliphatic alcohol by weight of the total composition. In some advantageous embodiments the ink composition can comprise a high alcohol content enabling high print definition on the surface of the substrate and faster drying time.

In certain embodiments said ink composition can comprise said at least one water miscible C₁ to C₄ aliphatic alcohol in an amount of about 10% to about 95% or to about 99% by weight of the total composition. In certain embodiments said ink composition can comprise said at least one water miscible C₁ to C₄ aliphatic alcohol in an amount of about 20% to about 95% or to about 99% by weight of the total composition. In certain embodiments said ink composition can comprise said at least one water miscible C₁ to C₄ aliphatic alcohol in an amount of about 30% to about 95% or to about 99% by weight of the total composition. In certain embodiments said ink composition can comprise said at least one water miscible C₁ to C₄ aliphatic alcohol in an amount of about 40% to about 95% or to about 99% by weight of the total composition. In further embodiments said ink composition can comprise said at least one water miscible C₁ to C₄ aliphatic alcohol in an amount of about 70% to about 95% or to about 99% by weight of the total composition. In still further embodiments said ink composition can comprise said at least one water miscible C₁ to C₄ aliphatic alcohol in an amount of about 85% to about 95% by weight of the total composition.

In some embodiments said at least one water miscible C₁ to C₄ aliphatic alcohol can be selected from a C₂ or C₃ aliphatic alcohol. In some embodiments said at least one water miscible C₁ to C₄ aliphatic alcohol can be selected from the group consisting of: propanol, isopropanol and ethanol. In some embodiments said at least one water miscible C₁ to C₄ aliphatic alcohol can comprise or consist of ethanol.

In some embodiments said ink composition can comprise at least about 1% water by weight of the total composition. In some embodiments said ink composition can comprise between about 1% and about 60% water by weight of the total composition. In some embodiments said ink composition can comprise between about 1% and about 30% water by weight of the total composition.

In some embodiments said ink composition can comprise said colorant in an amount of about 0.01% to about 10% by weight of the total composition. In some embodiments said ink composition can comprise said colorant in an amount of about 0.01% to about 5% by weight of the total composition.

In some embodiments said ink composition can comprise at least one metal salt. In some preferred embodiments said at least one metal salt can be selected from the group consisting of: an aluminium salt, an iron salt, a manganese salt, a calcium salt, a potassium salt and a magnesium salt. In some preferred embodiments said at least one metal salt can be selected from an iron salt or an aluminium salt. In some embodiments said ink composition can comprise said at least one metal salt in an amount of about 0.1% to about 10% by weight of the total composition. In further embodiments said ink composition can comprise said at least one metal salt in an amount of about 0.5% to about 2% by weight of the total composition.

In some embodiments said ink composition can comprise glycerol. In some embodiments said ink composition can comprise glycerol in an amount of about 1% to about 15% by weight of the total composition. In some embodiments said ink composition can comprise glycerol in an amount of about 1% to about 10% by weight of the total composition. In further embodiments said ink composition can comprise glycerol in an amount of about 1% to about 3% by weight of the total composition.

In some embodiments said ink composition can comprise at least one dispersing agent. In some embodiments said ink composition can comprise said dispersing agent in an amount of about 0.1% to about 5% by weight of the total composition. In some embodiments said dispersing agent can be selected from a modified lignin, an anionic lignosulfonate or a modified anionic sulfonate.

In some embodiments said ink composition can be free or substantially free from hydroxypropylcellulose. The ink composition may thus exclude hydroxypropylcellulose binders that are often employed in other ink compositions known in the art. In this context “substantially free from hydroxypropylcellulose” refers to ink compositions that comprise less than 10%, preferably less than 5%, more preferably less than 1%, more preferably less than 0.1% and most preferably less than 0.01% hydroxypropylcellulose by weight of the total composition.

In some embodiments said colorant can comprise at least one compound selected from curcumin. In some embodiments said colorant can consist of curcumin. In some advantageous embodiments the inclusion of at least one compound selected from curcumin can introduce orange/yellow to the colour palette provided by the ink composition of the invention. Curcumin may be present in its neutral form, as the diketone or enol, or in an anionic form, such as an enolate or phenolate salt.

In some embodiments said curcumin can be obtained from turmeric. In some embodiments said curcumin can be of the formula (II):

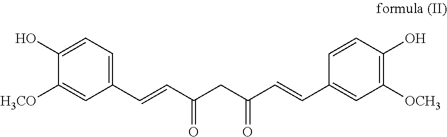 [SMILES: COc1cc(/C=C/C(=O)CC(=O)/C=C/c2ccc(O)c(OC)c2)ccc1O]

In some embodiments said ink composition can comprise said curcumin in an amount of about 0.01% to about 5% by weight of the total composition.

In some embodiments said colorant can comprise at least one compound selected from carminic acid. In some embodiments said colorant can consist of carminic acid. In some advantageous embodiments the inclusion of at least one compound selected from carminic acid can introduce pink to the colour palette provided by the ink composition of the invention. In some embodiments wherein said colorant comprises carminic acid or said colorant consists of carminic acid, said ink composition can be free or substantially free from hydroxypropylcellulose.

In some embodiments said carminic acid can be obtained from cochineal. In some embodiments said colorant can comprise carminic acid or salts thereof wherein said carminic acid is of the formula (III):

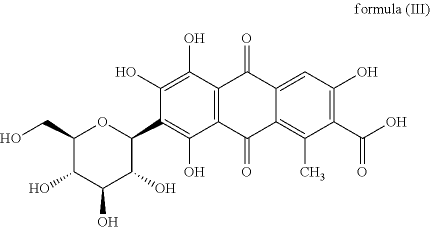 [SMILES: Cc1c(C(=O)O)c(O)cc2c1C(=O)c1c(O)c([C@@H]3O[C@H](CO)[C@@H](O)[C@H](O)[C@H]3O)c(O)c(O)c1C2=O]

In some embodiments said ink composition can comprise said carminic acid in an amount of about 0.01% to about 5% by weight of the total composition.

In some embodiments said colorant can comprise at least one anthocyanin compound and at least one compound selected from carminic acid. In further embodiments said colorant can consist of one or more anthocyanin compounds and carminic acid. In some advantageous embodiments the combination of at least one anthocyanin compound and at least one compound selected from carminic acid can introduce purple to the colour palette provided by the ink composition of the invention.

In some embodiments said colorant can comprise at least one compound selected from curcumin and at least one compound selected from carminic acid. In some embodiments said colorant can consist of curcumin and carminic acid. In some advantageous embodiments the combination of at least one compound selected from curcumin and at least one compound selected from carminic acid can introduce red to the colour palette provided by the ink composition of the invention.

In further embodiments said colorant can comprise at least one anthocyanin compound, at least one compound selected from curcumin and at least one compound selected from carminic acid. In still further embodiments said colorant can consist of one or more anthocyanin compounds, curcumin and carminic acid. In some advantageous embodiments the combination of at least one anthocyanin compound, at least one compound selected from curcumin and at least one compound selected from carminic acid can introduce brown to the colour palette provided by the ink composition of the invention.

In a second aspect of the invention there is provided an ink composition for marking a substrate, said ink composition comprising at least one water miscible C₁ to C₄ aliphatic alcohol, water and a colorant wherein said colorant is obtained from a natural source and comprises at least one compound selected from anthocyanins and wherein said ink composition further comprises at least one metal salt.

In some embodiments of the second aspect of the invention, said at least one metal salt can be selected from the group consisting of: an aluminium salt, an iron salt, a manganese salt, a calcium salt, a potassium salt and a magnesium salt. In some preferred embodiments said at least one metal salt can be selected from an iron salt or an aluminium salt.

In some embodiments of the second aspect of the invention, said ink composition further comprises at least one organic acid comprising one or more carboxylic acid moieties. In some embodiments said at least one organic acid can be acetic acid.

The second aspect of the invention can comprise any feature or any permitted combination of features described in relation to the first aspect of the invention.

In a third aspect of the invention there is provided the use of the ink composition of the first aspect of the invention or the second aspect of the invention for marking the surface of an eggshell.

In some embodiments of the third aspect of the invention there is provided the use of the ink composition of the first aspect of the invention for marking the surface of an eggshell wherein said ink composition can comprise at least one water miscible C₁ to C₄ aliphatic alcohol, water and a colorant wherein said colorant is obtained from a natural source and comprises at least one compound selected from anthocyanins and wherein said ink composition further comprises at least one organic acid comprising one or more carboxylic acid moieties. In some embodiments said at least one organic acid can be acetic acid.

In further embodiments of the invention there is provided the use of the ink composition of the first aspect of the invention or the second aspect of the invention for marking a food product. In some embodiments there is provided the use of said ink composition for marking the surface of a foodstuff.

In a fourth aspect of the invention there is provided a marked egg, of which the eggshell surface is marked with the ink composition of the first aspect or the second aspect of the invention.

In a fifth aspect of the invention there is provided a method of marking an eggshell comprising marking the eggshell surface with the ink composition of the first aspect or the second aspect of the invention.

### BRIEF DESCRIPTION OF THE DRAWINGS

Embodiments of the invention are further described hereinafter with reference to the accompanying drawings, in which:

FIG. 1 shows a reaction scheme demonstrating the structural changes anthocyanins are said to undergo at different pH values;

FIG. 2 shows the ink compositions 1 to 7 as described in Table 3 when deposited onto the surface of an eggshell;

FIG. 3 shows an ink composition of the present invention following application to an eggshell surface using a fountain pen.

### DETAILED DESCRIPTION

The present invention relates to an ink composition having a colorant that is obtained from naturally available materials. When the ink composition is applied to a substrate, the colour emanating from the extract of the natural material can be retained on the surface of the substrate. A variety of different colours can be created depending on the origin and combinations of the naturally derived materials. The ink composition of the invention can provide a water-fast, versatile means of labelling a substrate but with reduced environmental and toxicological impact when compared to currently available products.

As used herein, the term “water-fast” is intended to mean that the dried ink composition following application to the substrate is substantially insoluble in water.

In some embodiments the colorant of the ink composition can be obtained from a botanical source such as fruit and particular vegetables. Particularly said botanical source can comprise a multiplicity of polyphenolic materials including anthocyanin compounds. In some embodiments extracts of said polyphenolic materials including anthocyanin compounds can be obtained from blackcurrants (Ribes nigrum), blackberries (Rubus spp.), blueberries, cranberries (Vaccinium spp.), bilberries (especially Vaccinium myrtillus), strawberries (Fragaria spp.), grapes (Vitis spp.), chokeberries (Aronia spp.), Saskatoon berries (Amelanchier anifolia), sea-buckthorn (Hippophae spp.), mulberries (Morus spp.), acai (Euterpe spp.), cherries (Prunus spp.), red cabbage (Brassica spp.), black carrots (Daucus carota), and/or figs (Ficus spp.).

In some embodiments the colorant can be obtained from blackcurrants. In other embodiments the colorant can be obtained from chokeberries.

In some embodiments the anthocyanin compounds can be of the formula (I):

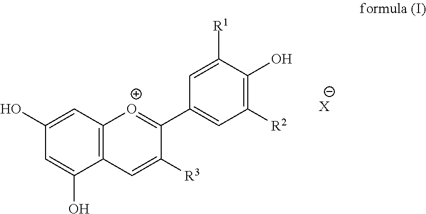

wherein R¹ and R² areeach independently selected from the group consisting of: H, OH and OCH₃;
R³ is selected from OH or an O-glycosyl group; and
X is a counter ion.

In embodiments wherein R³ is selected from OH, said anthocyanin compounds are known as aglycone anthocyanidins.

In embodiments wherein R³ is selected from an O-glycosyl group, said anthocyanin compounds are known as glycosylated anthocyanins.

In some embodiments X can be selected from the group of anions whose conjugate acids have a pKₐ of less than 10. In some embodiments X can be selected from the group of anions whose conjugate acids have a pKₐ of less than 6.

Typical examples of suitable anions as X consist of: chloride, bromide, iodide, sulphate, bisulphate, carbonate, oxalate, ascorbate, bicarbonate, succinate, citrate, lactate, formate, acetate and tartrate.

In some embodiments said anthocyanin compounds can be aglycone anthocyanidins.

In particular embodiments said aglycone anthocyanidins can include the compounds identified in Table 1:

TABLE 1
Examples of aglycone anthocyanidins of formula (I)

| Name | R¹ | R² | R³ |
|---|---|---|---|
| Pelargonidin | H | H | OH |
| Cyanidin | OH | H | OH |
| Peonidin | OCH₃ | H | OH |
| Delphinidin | OH | OH | OH |
| Petunidin | OH | OCH₃ | OH |
| Malvinidin | OCH₃ | OCH₃ | OH |

In some embodiments said aglycone anthocyanidins can exhibit the wavelengths as listed in Table 2:

TABLE 2
λ max values for the aglycone anthocyanidins listed in Table 1:

| Name | λ max (nm) |
|---|---|
| Pelargonidin | 503 |
| Cyanidin | 517 |
| Peonidin | 517 |
| Delphinidin | 526 |
| Petunidin | 526 |
| Malvidin | 529 |

In some embodiments said anthocyanin compounds can be glycosylated anthocyanins. Particularly, said anthocyanin compounds can be glycosylated anthocyanins wherein said glycosylation comprises a monosaccharide or disaccharide.

Active anthocyanin compounds can comprise various O-glycosyl groups as the R³ group, for example monosaccharides or polysaccharides such as disaccharides or trisaccharides. Optionally, these glycosyl moieties can include further acyl substitution, thereby providing a multitude of naturally occurring anthocyanins. In some embodiments monosaccharide groups can include O-glucoside, O-rhamnoside, O-arabinoside, O-xyloside and O-galactoside. Preferred di- and trisaccharides can typically be combinations of these monosaccharide groups, for example O-rutinoside (glucose+rhamnose), O-sophoroside (glucose+glucose) and O-primeveroside (glucose+xylose). Due to the nature of the associated bio-synthetic pathways of anthocyanin formation, particular botanical sources contain specific combinations of multiple anthocyanins. In fact, particular fruits and, indeed, varieties within species, have specific and characteristic profiles of anthocyanins, giving rise to variations in observed colour. For example, the four major anthocyanins present in blackcurrant fruit are cyanidin-3-O-glucoside, cyanidin-3-O-rutinoside, delphinidin-3-O-glucoside and delphinidin-3-O-rutinoside, and these derivatives account for >97% of the total anthocyanins in the fruit.

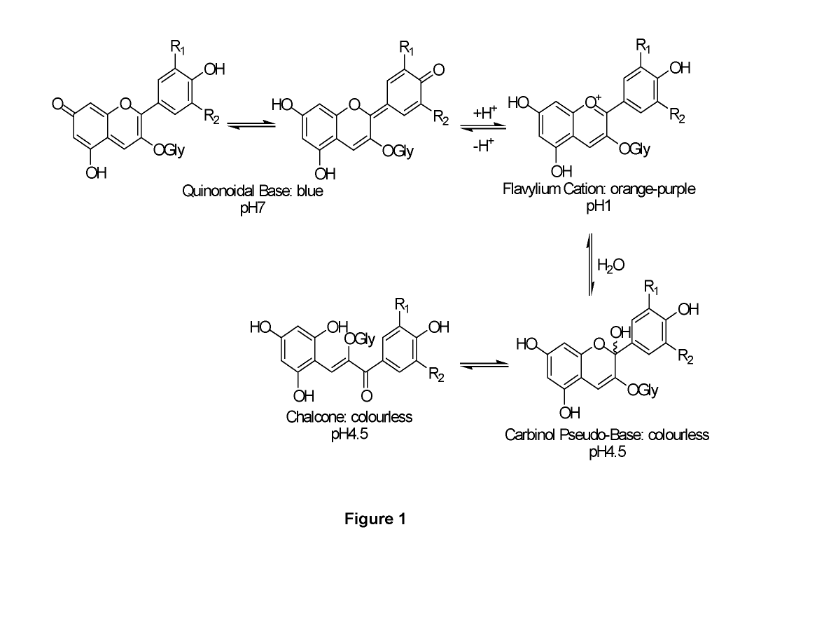

Once isolated, the observed colour of the anthocyanins is influenced by the chemical environment, particularly solvatochromatic effects and pH, and this allows for potential colour control in formulations incorporating these compounds. The colour of an anthocyanin pigment is strongly influenced by the pH of the environment and the substitution pattern. At pH<3 the anthocyanin exists as the flavylium cation and may appear red to violet-red depending on the substitution pattern. An increase in pH leads to kinetic and thermodynamic competition between two possible reactions (see FIG. 1). One is the hydration reaction of the cation which yields a colourless carbinol pseudo-base which may undergo ring opening to chalcone pseudo-bases. Alternatively, proton transfer reactions of the acidic anthocyanidin hydroxyl groups may occur, producing purple quinonoid bases; further deprotonation may occur around pH 6-7.

In some embodiments said ink composition can comprise or can consist of one or more anthocyanin compounds. In some embodiments wherein said ink composition comprises a colorant that is predominantly selected from anthocyanin compounds or consists of anthocyanin compounds, the ink composition can give rise to a blue coloration following application to the substrate. In some embodiments said ink composition can comprise said one or more anthocyanin compounds in an amount of about 0.01% to about 10% by weight of the total composition. In further embodiments said ink composition can comprise said one or more anthocyanin compounds in an amount of about 0.01% to about 5% by weight of the total composition. In still further embodiments said ink composition can comprise said one or more anthocyanin compounds in an amount of about 0.1% to about 2% by weight of the total composition. In one particular embodiment, said ink composition can comprise said one or more anthocyanin compounds in an amount of about 1% by weight of the total composition, which can yield a blue colour, as demonstrated in example 7.

In order to prepare the anthocyanin compounds for use in the ink compositions, the compounds can first be extracted from a botanical source and then subjected to a purification process. Typically, extraction can be achieved by the action of aqueous media, preferably water, with or without the application of heat. Thus, if the botanical source is fruit, the anthocyanin compounds can conveniently be extracted by heating the fruit in water. Optionally, said aqueous media may additionally comprise glycerol or ethanol and may be acidified to pH<4 by addition of any of, for example, hydrochloric, hydrobromic, hydroiodic, nitric, phosphoric, sulphuric, acetic, trifluoroacetic, ascorbic, citric, succinic, formic, lactic, benzoic, tartaric, camphor-10-sulphonic or oxalic acids.

The subsequent purification process requires isolation of the anthocyanin components from the crude extract or fruit juice at the correct dilution. Suitable methods for achieving this include adsorption/desorption techniques using various porous solids and/or resins. Successful results were achieved with non-ionic aliphatic acrylic ester polymers, proteinaceous materials, polysaccharides, and modified variants thereof. Following removal of unwanted extraneous components, the target compounds may be eluted in an ethanolic liquid phase. Optionally, said elution media may additionally comprise glycerol or isopropyl alcohol, in conjunction with heating, typically at 20-100° C., and be mildly acidified by addition of any of, for example, hydrochloric, hydrobromic, hydroiodic, nitric, phosphoric, sulphuric, acetic, trifluoroacetic, ascorbic, citric, formic, lactic, tartaric, camphor-10-sulphonic or oxalic acids (0.01-1.0M).

The eluted solution of anthocyanins may then be powdered following removal of solvent by evaporation or by common powder forming techniques such as recrystallisation or spray drying, or by any other such technique to produce a powder. Alternatively, a concentrated liquid solution may be produced enabling further incorporation into other media.

Examples of suitable extraction and preparation methods for the anthocyanin compounds are further described in WO2010/131049, the contents of which are herein incorporated by reference.

In further embodiments, the colorant of the ink composition of the invention can be obtained from turmeric. In such embodiments, the colorant can comprise or consist of curcumin. In some embodiments said curcumin can be of the formula (II):

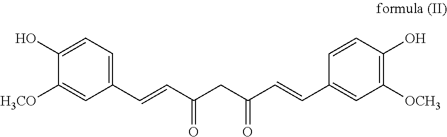 [SMILES: COc1cc(/C=C/C(=O)CC(=O)/C=C/c2ccc(O)c(OC)c2)ccc1O]

Furthermore said curcumin can exist in various tautomeric forms. For example, curcumin can adopt both the keto form as shown in formula (II) and an enol form as shown below in formula (IIA):

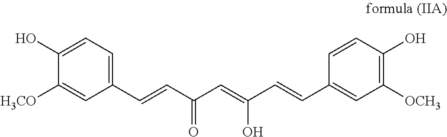 [SMILES: COc1cc(/C=C/C(=O)/C=C(O)/C=C/c2ccc(O)c(OC)c2)ccc1O]

In addition, said keto or enol forms of curcumin can be deprotonated to form an anionic form such as an enolate or phenolate. It will be understood however that any reference to curcumin as herein described is to be construed as including said curcumin compound as outlined above along with any of its tautomeric or anionic forms.

In some embodiments said ink composition can comprise or consist of at least one compound selected from curcumin. In embodiments wherein said ink composition comprises a colorant that is predominantly curcumin or consists of curcumin, the composition can exhibit an orange/yellow coloration following application to the substrate. In some embodiments said ink composition can comprise said at least one compound selected from curcumin in an amount of about 0.01% to about 10% by weight of the total composition. In further embodiments said ink composition can comprise said at least one compound selected from curcumin in an amount of about 0.01% to about 5% by weight of the total composition. In still further embodiments said ink composition can comprise said at least one compound selected from curcumin in an amount of about 0.05% to about 0.5% by weight of the total composition. In one particular embodiment, said ink composition can comprise said curcumin in an amount of about 0.2% by weight of the total composition, which can yield a yellow colour, as demonstrated in example 1.

In order to prepare curcumin for use in the ink compositions of the invention, curcumin can be extracted from ground turmeric (Curcuma longa) using ethanol or methanol in combination with water. Extraction can be conducted at room temperature for over 4 hours (up to 4% yield w/w), or using a Soxhlet extractor for up to 7 hours (up to 12% yield w/w). Minor contaminants include demethoxycurcumin and bis(demethoxy)curcumin, which may comprise 10-20% w/w of the extract.

In certain embodiments said colorant can comprise at least one anthocyanin compound and at least one compound selected from curcumin. In further embodiments said colorant can consist of one or more anthocyanin compounds and curcumin. In such embodiments the ink composition, following application to the substrate, can exhibit a green coloration. Furthermore, the relative amounts of the respective curcumin and anthocyanin components can be altered within the ranges noted above in order to attain a desired shade of green. In one particular embodiment, said ink composition can comprise one or more anthocyanin compounds in a combined amount of about 0.5% by weight of the total composition and curcumin in an amount of about 0.1% by weight of the total composition, which can yield a green colour, as demonstrated in example 6.

In further embodiments, the colorant of the ink composition of the invention can be obtained from cochineal. In such embodiments said colorant can comprise carminic acid or salts thereof. Particularly, said carminic acid can be of the formula (III):

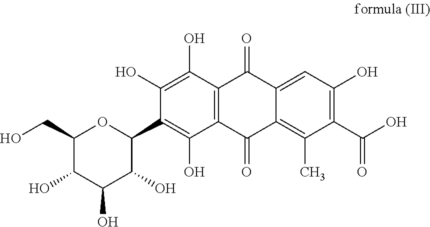 [SMILES: Cc1c(C(=O)O)c(O)cc2c1C(=O)c1c(O)c([C@@H]3O[C@H](CO)[C@@H](O)[C@H](O)[C@H]3O)c(O)c(O)c1C2=O]

In some embodiments said ink composition can comprise or can consist of at least one compound selected from carminic acid. In embodiments wherein said ink composition comprises a colorant that is predominantly carminic acid or consists of carminic acid, the composition can exhibit a pink coloration following application to the substrate. In some embodiments said ink composition can comprise said at least one compound selected from carminic acid in an amount of about 0.01% to about 10% by weight of the total composition. In further embodiments said ink composition can comprise said at least one compound selected from carminic acid in an amount of about 0.01% to about 5% by weight of the total composition. In still further embodiments said ink composition can comprise said at least one compound selected from carminic acid in an amount of about 0.01% to about 0.2% by weight of the total composition. In one particular embodiment, said ink composition can comprise carminic acid in an amount of about 0.1% by weight of the total composition, which can yield a pink colour, as demonstrated in example 3.

In order to prepare carminic acid for use in the ink compositions of the invention, carminic acid can be extracted from the dried bodies of females of the Dactylopius coccus (cochineal) insect species using ethanol or methanol in combination with water. Yields of up to 18% can be achieved, however, under pressure these can be increased significantly; using pressurised liquid extraction using ethanol/water at 150° C. gives up to 42% yield; using supercritical carbon dioxide (scCO₂), yields up to 39% can be achieved (40° C., 150 bar) using a methanol modifier. Traditional extraction methods involve several drawbacks (e.g. high extraction time, low selectivity and low extraction efficiency, toxic solvents), but these new extraction methods avoid these disadvantages.

In certain embodiments said colorant can comprise at least one anthocyanin compound and at least one compound selected from carminic acid. In further embodiments said colorant can consist of one or more anthocyanin compounds and carminic acid. In such embodiments the ink composition, following application to the substrate, can exhibit a purple coloration. Furthermore, the relative amounts of the respective carminic acid and anthocyanin components can be altered within the ranges noted above in order to attain a desired shade of purple. In one particular embodiment, said ink composition can comprise one or more anthocyanin compounds in a combined amount of about 0.5% by weight of the total composition and carminic acid in an amount of about 0.05% by weight of the total composition, which can yield a purple colour, as demonstrated in example 2.

In other embodiments said colorant can comprise at least one compound selected from curcumin and at least one compound selected from carminic acid. In further embodiments said colorant can consist of curcumin and carminic acid. In such embodiments the ink composition, following application to the substrate, can exhibit a red coloration. Again, the relative amounts of the respective curcumin and carminic acid components can be altered within the ranges noted above in order to attain a desired shade of red. In one particular embodiment, said ink composition can comprise curcumin in an amount of about 0.1% by weight of the total composition and carminic acid in an amount of about 0.1% by weight of the total composition, which can yield a red colour, as demonstrated in example 4.

In further embodiments said colorant can comprise at least one anthocyanin compound, at least one compound selected from curcumin and at least one compound selected from carminic acid. In still further embodiments said colorant can consist of one or more anthocyanin compounds, curcumin and carminic acid. In such embodiments the ink composition, following application to the substrate, can exhibit a brown coloration. As noted above, the relative amounts of the respective anthocyanin, curcumin and carminic acid components can be altered within the previously quoted ranges in order to attain a desired shade of brown. In one particular embodiment, the ink composition can comprise one or more anthocyanin compounds in a combined amount of about 0.3% by weight of the total composition, curcumin in an amount of about 0.07% by weight of the total composition and carminic acid in an amount of about 0.03% by weight of the total composition, which can yield a brown colour, as demonstrated in example 5.

The ink composition of the invention can further comprise an alcohol. Specifically, said alcohol can be a water miscible alcohol having a carbon chain consisting of 1 to 4 carbons. In some embodiments said alcohol can be a monohydric alcohol. In some embodiments said alcohol can be a water miscible alcohol having a carbon chain consisting of 2 or 3 carbons. In some embodiments said alcohol can be selected from the group consisting of: propanol, isopropanol and ethanol. In some preferred embodiments said alcohol can comprise or consist of ethanol.

In some advantageous embodiments, the ink composition of the invention can permit the inclusion of a higher alcohol content than typical food grade ink compositions known in the prior art. In some embodiments said ink composition can comprise at least 10%, at least 20% or at least 30% of said at least one water miscible alcohol by weight of the total composition. In certain embodiments said ink composition can comprise at least 40% by weight said water miscible alcohol of the total composition. In some embodiments said ink composition can comprise at least 50% by weight, in certain embodiments at least 60% by weight, in further embodiments at least 70% by weight, in still further embodiments at least 75% by weight, and in yet still further embodiments at least 80% by weight said water miscible alcohol of the total composition. In other embodiments said ink composition can comprise at least 90% by weight said water miscible alcohol of the total composition and in further embodiments said ink composition can comprise at least 95% by weight said water miscible alcohol of the total composition. The inclusion of a high alcohol content can facilitate a faster drying time for the ink compositions once applied to the surface of the substrate. In some advantageous embodiments, drying time can be less than 5 seconds following initial application of the ink composition to the substrate. Furthermore, the method of application using the ink compositions of the invention does not require heat to effectively mark the substrate.

In certain embodiments said ink composition can comprise said at least one water miscible alcohol in an amount of about 10% to about 95%, about 20% to about 95% or about 30% to about 95% by weight of the total composition. In certain embodiments said ink composition can comprise said water miscible alcohol in an amount of about 40% to about 95% by weight of the total composition. In further embodiments said ink composition can comprise said water miscible alcohol in an amount of about 70% to about 95% by weight of the total composition. In yet further embodiments said ink composition can comprise said water miscible alcohol in an amount of about 70% to about 90% by weight of the total composition. In still further embodiments said ink composition can comprise said at least one water miscible C₁ to C₄ aliphatic alcohol in an amount of about 85% to about 95% by weight of the total composition. In yet still further embodiments said ink composition can comprise said water miscible alcohol in an amount of about 75% to about 85% by weight of the total composition. In one particular embodiment said ink composition can comprise said water miscible alcohol in an amount of about 75% to about 80% by weight of the total composition.

In addition, the ink composition of the invention can include water to aid the solubility of the alcohol component. In some embodiments said ink composition can comprise at least about 1% water by weight of the total composition. In certain embodiments said ink composition can comprise between about 1% and about 60% water by weight of the total composition. In some embodiments said ink composition can comprise between about 1% and about 30% water by weight of the total composition. In further embodiments said ink composition can comprise between about 1% and about 20% water by weight of the total composition. In still further embodiments said ink composition can comprise between about 15% and about 25% water by weight of the total composition. In one particular embodiment said ink composition can comprise between about 18% and about 20% water by weight of the total composition.

The ink composition of the invention is particularly useful for the marking or labelling of food products. Thus the substrate to which the ink composition is to be applied can contain or consist of materials suitable for ingestion by humans or animals. In some embodiments the substrate can be the surface of a foodstuff.

Thus in some embodiments said ink composition can consist of food grade materials. In this context, “food grade materials” can consist of substances which, when brought into contact with food, or in the area near food, do not contaminate the food with material above a predetermined threshold considered safe for human exposure. Said predetermined threshold can be set by an appropriate regulatory or governmental body such as, for example, the USFDA or the European Food Safety Authority (EFSA). The ink composition can therefore consist of ingredients that, following their application to the target substrate, are safe for human consumption and non-toxic. For example, reports providing toxicological data on curcumin, carminic acid and anthocyanins support the view that such compounds pose no threat to human health and they are approved for use as food colorants (E100, E120 and E163 respectively).

In further embodiments the substrate to which the ink composition is to be applied can comprise calcium and in still further embodiments said substrate can comprise calcium carbonate. In certain embodiments said substrate can comprise a mixture of proteins or a protein matrix. In a particularly preferred embodiment said substrate can comprise an eggshell. When applied to an eggshell surface, the ink compositions of the present invention can form an indelible mark on the surface but without penetration into the egg white and yolk.

In some embodiments said ink composition can further comprise at least one organic acid. The at least one organic acid can be a weak acid. The at least one organic acid can have pKₐ or acid ionisation constants with values less than 10. In some embodiments said at least one organic acid can have pKₐ values or acid ionisation constants between 1 and 5. In some embodiments said at least one organic acid can have 1 to 6 carbon atoms.

In some embodiments said at least one organic acid can comprise one or more carboxylic acid moieties. In some embodiments said at least one organic acid can be selected from the group consisting of: acetic acid, gluconic acid, lactic acid, formic acid, citric acid, malic acid, succinic acid, glutaric acid, oxalic acid, adipic acid, fumaric acid, tartaric acid.

In another embodiment said at least one organic acid can be ascorbic acid.

In some embodiments said ink composition can comprise said at least one organic acid in an amount of about 0.1% to about 30% by weight of the total composition. In some embodiments said ink composition can comprise said at least one organic acid in an amount of about 0.1% to about 25% or in an amount of about 0.1% to about 20% by weight of the total composition. In some embodiments said ink composition can comprise said at least one organic acid in an amount of about 0.1% to about 15% by weight of the total composition. In further embodiments said ink composition can comprise said at least one organic acid in an amount of about 1% to about 10% by weight of the total composition. In still further embodiments said ink composition can comprise said at least one organic acid in an amount of about 1% to about 5% by weight of the total composition.

The presence of at least one organic acid comprising one or more carboxylic acid moieties in the ink composition can improve the affinity and adherence of the colorant to the surface of the substrate. For example, the inclusion of acetic acid as the organic acid provides a significant improvement for the affinity of anthocyanins to the substrate surface in embodiments wherein the substrate is an eggshell. Without wishing to be bound by any particular theory, the present inventors believe that the multiplicity of polyphenolic groups within anthocyanin compounds can co-ordinate with the basic, calcium carbonate surface of the eggshell. Neutralisation of the surface of the eggshell takes place by the action of acetic acid (e.g. by formation of bicarbonate) causing a rise in pH and formation of the neutral quinonoidal base as illustrated in FIG. 1. The quinonoidal base has substantially lower water solubility than the cationic flavylium form, but retains hydrogen bonding interactions with the surface of the eggshell. As the quinonoidal base contains both carbonyl and hydroxyl moieties on adjacent carbon atoms, chelation with calcium ions (Ca²⁺) is facilitated. Consequently, a bidentate ligand can be formed with one hydroxyl and one carbonyl moiety or, alternatively, a bidentate ligand can be formed with two hydroxyl moieties. This phenomenon may further improve the fastness or binding of the anthocyanin compounds to the egg shell surface.

Both curcumin and carminic acid as outlined above can display high affinity for eggshells. Without wishing to be bound by any particular theory, the present inventors believe that the presence of both carbonyl and hydroxyl moieties in curcumin and carminic acid can aid chelation with calcium ions (Ca²⁺) present in the shell. It is thus hypothesized that both curcumin and carminic acid can form bidentate chelate ligands with calcium comprised in the eggshell.

In certain embodiments the ink composition can comprise at least one metal salt. The at least one metal salt can be present in an amount of about 0.1 to about 10% by weight of the total composition. In further embodiments the at least one metal salt can be present in an amount of about 0.5% to about 2% by weight of the total composition. In particular embodiments the at least one metal salt can be present in an amount of about 1% by weight of the total composition. In some embodiments the at least one metal salt can be selected from the group consisting of: an aluminium salt, an iron salt, a manganese salt, a calcium salt, a potassium salt and a magnesium salt. Aluminium salts and iron salts are particularly preferred. Exemplary aluminium salts include, but are not limited to, aluminium sulphate, aluminium chloride, aluminium acetate, and aluminium lactate. Exemplary iron salts include, but are not limited to iron lactate, iron acetate, iron sulphate, and iron chloride.

The inclusion of a metal salt can improve the water-fastness and durability of the printed ink on the substrate and particularly wherein the substrate is an eggshell. Furthermore, the incorporation of metal salts such as aluminium and iron salts within the ink composition when combined with anthocyanin compounds can promote the formation of blue and black complexes.

In some embodiments the ink composition can comprise glycerol. In such embodiments the ink composition can comprise glycerol in an amount of about 1% to about 15% or to about 10% by weight of the total composition. In further embodiments said ink composition can comprise glycerol in an amount of about 1% to about 3% by weight of the total composition. The inclusion of glycerol can assist with formulation and stability of the ink composition and may reduce or prevent precipitation of solids.

In certain embodiments the ink composition can comprise at least one dispersing agent. The dispersing agent can be present in an amount of about 0.1% to about 5% by weight of the total composition. In some embodiments the dispersing agent can be selected from a modified lignin, an anionic lignosulfonate or a modified anionic sulfonate. Examples of suitable dispersing agents for use in the composition include, but are not limited to Ufoxane 3A.

The inclusion of a dispersing agent can further stabilize the ink composition and reduce or prevent precipitation of solids. The incorporation of a dispersing agent is particularly advantageous for compositions containing curcumin in order to improve solubility.

The ink compositions of the present invention as outlined above thereby enable the deposition of a durable, water-fast mark on the surface of the substrate. In embodiments wherein the substrate is an eggshell, the ink composition of the invention can provide an indelible colour mark on its surface that is resistant to boiling. Use of the ink composition ensures minimal colour bleed or wicking of the colour and consequently there is no effect on the readability of the mark immediately after printing or during storage of the eggs in humid environments. Furthermore, the colorants comprising anthocyanins, curcumin and carminic acid can each be used alone or blended to provide a colour palette consisting of, but not limited to, orange/yellow, purple, pink, red, brown, green, black and blue. In addition, the ink composition in accordance with the present invention emanates no discernible odour following its application to the substrate.

The mark provided on the surface of the substrate can be in the form of a barcode or a QR code. In further embodiments of the invention there is provided a method of applying the ink composition to the substrate. The ink composition of the invention can be adapted for different types of application methods. In certain embodiments the ink composition can be free from sodium sulfate which improves its application stability.

### EXAMPLES

Exemplary formulations of various ink compositions according to the present invention are shown in Table 3 below:

TABLE 3
Examples of ink compositions and resulting colour on eggshells.

| Example | Ink Composition | Ink Composition | Colour on |
|---|---|---|---|
| No. | (% w/v) | (% w/w) | Eggshells |
| 1 | Curcumin, 0.2%; | Curcumin, 0.24%; | Orange- |
| | Ethanol, 79.84%; | Ethanol, 75.76%; | yellow |
| | Water, 19.96%. | Water, 24.00%. | |
| 2 | Carminic Acid, 0.05%; | Carminic Acid, 0.06%; | Purple |
| | Anthocyanin, 0.5%; | Anthocyanin, 0.60%; | |
| | Acetic acid, 2.5%; | Acetic acid, 2.99%; | |
| | Ethanol, 77.56%; | Ethanol, 73.17%; | |
| | Water, 19.39%. | Water, 23.18%. | |
| 3 | Carminic Acid, 0.1%; | Carminic Acid, 0.12%; | Pink |
| | Ethanol, 79.92%; | Ethanol, 75.85%; | |
| | Water, 19.98%. | Water, 24.03%. | |
| 4 | Carminic Acid, 0.1%; | Carminic Acid, 0.12%; | Red |
| | Curcumin, 0.1%; | Curcumin, 0.12%; | |
| | Acetic acid, 2.5%; | Acetic acid, 2.99%; | |
| | Ethanol, 77.84%; | Ethanol, 73.49%; | |
| | Water, 19.46%. | Water, 23.28%. | |
| 5 | Carminic Acid, 0.03%; | Carminic Acid, 0.04%; | Brown |
| | Curcumin, 0.07%; | Curcumin, 0.08%; | |
| | Anthocyanin, 0.3%; | Anthocyanin, 0.36%; | |
| | Acetic acid, 1.7%; | Acetic acid, 2.04%; | |
| | Ethanol, 78.32%; | Ethanol, 74.03%; | |
| | Water, 19.58%. | Water, 23.46%. | |
| 6 | Curcumin, 0.1%; | Curcumin, 0.12%; | Green |
| | Anthocyanin, 0.5%; | Anthocyanin, 0.60%; | |
| | Acetic acid, 2.5%; | Acetic acid, 2.99%; | |
| | Ethanol, 77.52%; | Ethanol, 73.12%; | |
| | Water, 19.38%. | Water, 23.17%. | |
| 7 | Anthocyanin, 1.0%; | Anthocyanin, 1.19%; | Blue |
| | Acetic acid, 5.0%; | Acetic acid, 5.94%; | |
| | Ethanol, 75.2%; | Ethanol, 70.52%; | |
| | Water, 18.8%. | Water, 22.35%. | |

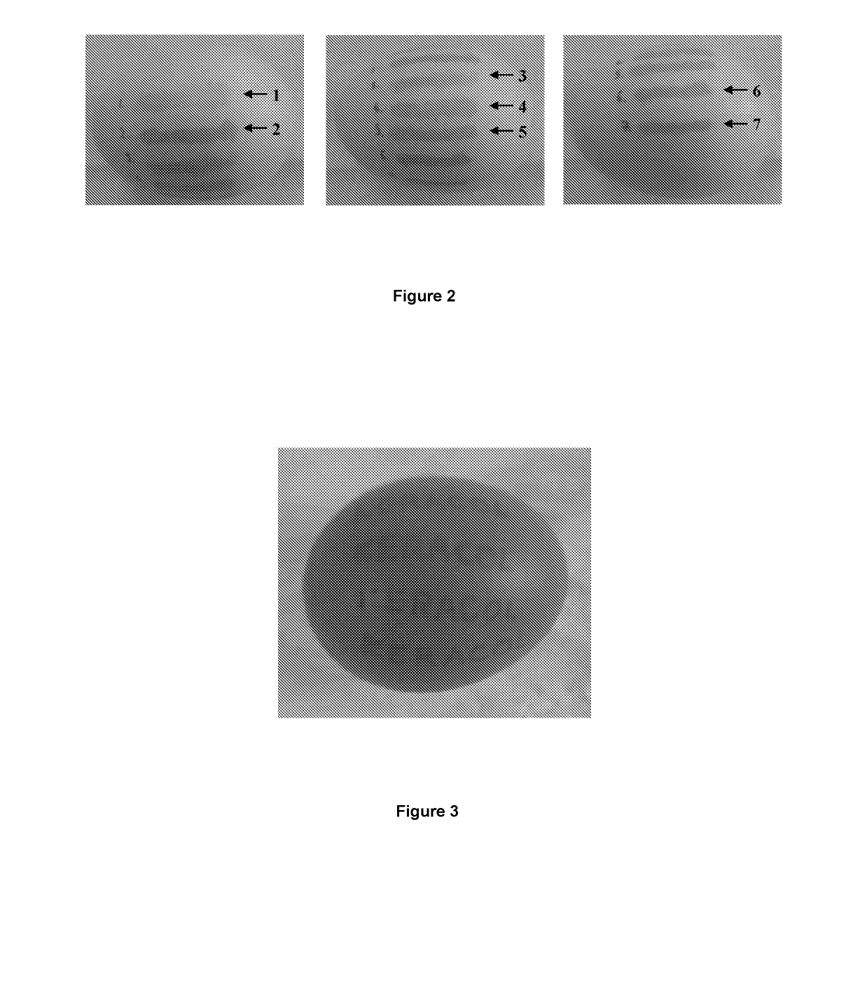

Ink compositions 1 to 7 were deposited onto an eggshell drop-wise and allowed to dry, typically taking between 1 to 5 seconds. The marked prints on the eggshell surface from each of the compositions could not be removed when washed with warm water and additional gentle abrasion demonstrating that the prints were durable and water-fast. Furthermore, the markings on the surface displayed good contrast against the eggshell background (see FIG. 2).

In a further experiment, the ink compositions were applied to the eggshell surface using a fountain pen. As shown in FIG. 3, the ink compositions were able to mark the eggshell surface with minimal spreading to give clearly visible characters. Furthermore, no penetration of the dye into the interior of the eggshell was observed and the markings were water-fast.

Further exemplary formulations of ink compositions according to the present invention are shown in Table 4 below:

TABLE 4
Further examples of ink compositions
and resulting colour on eggshells.

| Example | Ink Composition | Colour on |
|---|---|---|
| No. | (% w/w) | Eggshells |
| 8 | 5% Anthocyanin (from blackcurrant); | Black |
| | 1% Iron lactate; 5% Glucose; 38% Water; | |
| | 31% Ethanol; 20% Acetic acid | |
| 9 | 0.5% Anthocyanin (from blackcurrant); | Blue |
| | 1% Aluminum sulphate; 44% Water; | |
| | 34.5% Ethanol; 20% Acetic acid | |
| 10 | 5% Anthocyanin (from blackcurrant); | Blue |
| | 1% Aluminum sulphate; 5% Glycerol; | |
| | 44% Water; 25% Ethanol; 20% Acetic acid | |
| 11 | 0.1% Curcumin; | Green |
| | 0.2% Dispersing agent (Ufoxane 3A); | |
| | 0.5% Anthocyanin (from blackcurrant); | |
| | 44.2% Water; 35% Ethanol; 20% Acetic acid | |
| 12 | 0.1% Curcumin; | Green |
| | 0.5% Anthocyanin (from blackcurrant); | |
| | 3% Glycerol; 44.4% Water; | |
| | 32% Ethanol; 20% Acetic acid | |
| 13 | 1% Carminic acid; 0.1% Curcumin; | Red |
| | 1% Aluminum sulphate; 54.7% Water; | |
| | 43.2% Ethanol | |
| 14 | 2% Anthocyanin (from chokeberry); | Red |
| | 5% Citric acid; 41% Water; | |
| | 32% Ethanol; 20% Acetic acid | |
| 15 | 0.5% Carminic acid; 0.1% Curcumin; | Brown |
| | 0.2% Anthocyanin (from blackcurrant); | |
| | 1% Aluminum sulphate; | |
| | 54.9% Water; 43.3% Ethanol | |

Ink compositions 8 to 15 were applied to the eggshell surface using a fountain pen and allowed to dry, typically taking between 1 to 5 seconds. The marked prints on the eggshell surface from each of the compositions could not be removed when washed with warm water and additional gentle abrasion demonstrating that the prints were durable and water-fast. The mark on the eggshell surface showed minimal spreading to give clearly visible characters. Furthermore, the markings on the surface displayed good contrast against the eggshell background.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An ink composition for marking an eggshell, said ink composition comprising at least one water miscible C₁ to C₄ aliphatic alcohol, water and a colorant;
wherein said colorant is obtained from a natural source and comprises one or more compounds selected from the group consisting of: anthocyanins, curcumin and carminic acid.

2. (canceled)

3. The ink composition according to claim 1 wherein said ink composition further comprises at least one organic acid.

4. The ink composition according to claim 1 wherein said ink composition is free from erythrosine.

5. The ink composition according to claim 1 wherein said ink composition consists of food grade materials.

6. The ink composition according to claim 1 wherein said colorant comprises at least one compound selected from anthocyanins.

7. The ink composition according to claim 1 wherein said anthocyanins are obtained from a botanical source.

8. The ink composition according to claim 7 wherein said botanical source is selected from blackcurrants, blackberries, blueberries, cranberries, bilberries, strawberries, grapes, chokeberries, Saskatoon berries, sea-buckthorn, mulberries, acai, cherries, red cabbage, black carrots, and/or figs.

9. The ink composition according to claim 6 wherein said anthocyanin compounds are aglycone anthocyanidins or glycosylated anthocyanins of the formula (I): 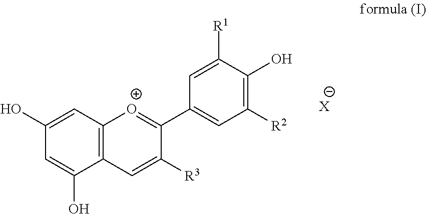
wherein R¹ and R² are, independently, H, OH or OCH₃, R³ is OH (aglycone anthocyanidins) or an O-glycosyl group (glycosylated anthocyanins), and X is a counter ion.

10. The ink composition according to claim 9 wherein X is selected from the group of anions whose conjugate acids have a pKₐ of less than 10 and can optionally be selected from the group consisting of: chloride, bromide, iodide, sulphate, bisulphate, carbonate, bicarbonate, citrate, succinate, oxalate, ascorbate, lactate, formate, acetate and tartrate.

11. The ink composition according to claim 9 wherein said O-glycosyl group comprises a monosaccharide, disaccharide, trisaccharide, or polysaccharide.

12. (canceled)

13. The ink composition according to claim 11 wherein said monosaccharide is selected from O-glucoside, O-rhamnoside, O-arabinoside, O-xyloside and O-galactoside or wherein said disaccharide is selected from O-rutinoside, O-sophoroside and O-primeveroside.

14. (canceled)

15. The ink composition according to claim 3 wherein said at least one organic acid has pKₐ values of less than 10.

16. (canceled)

17. The ink composition according to claim 3 wherein said at least one organic acid is selected from the group consisting of: acetic acid, gluconic acid, lactic acid, formic acid, citric acid, malic acid, succinic acid, glutaric acid, oxalic acid, adipic acid, fumaric acid, tartaric acid and ascorbic acid.

18. (canceled)

19. The ink composition according to claim 3 comprising said at least one organic acid in an amount of about 0.1% to about 30% by weight of the total composition.

20. (canceled)

21. (canceled)

22. The ink composition according to claim 1 comprising said at least one water miscible C₁ to C₄ aliphatic alcohol in an amount of about 20% to about 95% by weight of the total composition.

23. (canceled)

24. The ink composition according to claim 1 wherein said at least one water miscible C₁ to C₄ aliphatic alcohol is selected from the group consisting of: propanol, isopropanol and ethanol.

25. (canceled)

26. (canceled)

27. The ink composition according to claim 1 comprising between about 1% and about 60% water by weight of the total composition.

28. The ink composition according to claim 1 comprising said colorant in an amount of about 0.01% to about 10% by weight of the total composition.

29. The ink composition according to claim 1 wherein said ink composition comprises at least one metal salt.

30. The ink composition according to claim 29 wherein said at least one metal salt is selected from the group consisting of: an aluminium salt, an iron salt, a manganese salt, a calcium salt, a potassium salt and a magnesium salt.

31. The ink composition according to claim 29 comprising said at least one metal salt in an amount of about 0.1% to about 10% by weight of the total composition.

32. The ink composition according to claim 1 wherein said ink composition comprises glycerol in an amount of about 1% to about 15% by weight of the total composition.

33. The ink composition according to claim 1 wherein said ink composition comprises at least one dispersing agent in an amount of about 0.1% to about 5% by weight of the total composition.

34. The ink composition according to claim 33 wherein said dispersing agent is selected from a modified lignin, an anionic lignosulfonate or a modified anionic sulfonate.

35. The ink composition according to claim 1 wherein said ink composition is free from hydroxypropylcellulose.

36. The ink composition according to claim 1 wherein said colorant comprises curcumin.

37. The ink composition according to claim 36 wherein said curcumin is obtained from turmeric.

38. (canceled)

39. The ink composition according to claim 1 wherein said colorant comprises at least one compound selected from carminic acid and salts thereof.

40. The ink composition according to claim 39 wherein said carminic acid is obtained from cochineal.

41. (canceled)

42. The ink composition according to claim 1 wherein said colorant comprises at least one anthocyanin compound and at least one compound selected from carminic acid and salts thereof.

43. The ink composition according to claim 1 wherein said colorant comprises curcumin and at least one compound selected from carminic acid and salts thereof.

44. The ink composition according to claim 1 wherein said colorant comprises at least one anthocyanin compound, curcumin and at least one compound selected from carminic acid and salts thereof.

45. (canceled)

46. (canceled)

47. (canceled)

48. (canceled)

49. (canceled)

50. (canceled)

51. A marked egg, of which the eggshell surface is marked with the ink composition according to claim 1.

52. A method of marking an eggshell, the method comprising marking said eggshell surface with the ink composition according to claim 1.

53. (canceled)

54. (canceled)

55. (canceled)
